(19) United States
(12) Patent Application Publication
(10) Pub. No.: US 2007/0175340 A1
(43) Pub. Date: Aug. 2, 2007

(54) Cake stacking apparatus

(76) Inventors: Verlin C. Wise, Chillicothe, OH (US); Katherine E. Wise, Chillicothe, OH (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/342,451

(22) Filed: Jan. 30, 2006

(51) Int. Cl. A47J 37/07

(52) U.S. Cl. 99/450

(57) ABSTRACT

A cake stacking apparatus includes a base having a plurality of elongated rod members or the like that are configured to support a layer of a multi-layered cake. One or more alignment members may be slidably disposed on the rods. The rods extend through openings in the alignment members, and the alignment members thereby retain the elongated rods in a substantially parallel position relative to one another. An optional second alignment member may be utilized to position the distal ends of the elongated rods to facilitate positioning of the first alignment member onto the distal ends of the elongated rod members.

### BACKGROUND OF THE INVENTION

Cakes and the like commonly include several layers that are individually baked in cake pans, and stacked to form a multi-layered cake. Multi-layered cakes typically include frosting or the like between the layers of the cake, and the cake is also typically covered with frosting and/or the like.

Known methods for making multi-layered cake include baking the individual layers in baking pans. A first or lower layer is initially removed from the baking pan by turning the pan over to remove the layer and position the layer on a cake rack or other suitable support surface. The first layer is then covered with frosting or the like, and the second layer is positioned over the first layer by turning the pan over. The second layer is then covered with frosting. This process is repeated until the desired number of layers have been stacked on top of one another.

Substantial difficulty may be encountered during the cake making process due to the tendency of the cake layers to break apart or crumble as the upper layers are positioned on the cake layer immediately below. Particularly with larger, more elaborate cakes for weddings or other such major events, a substantial investment in time and material may be required to make the cake. Accordingly, crumbling or breaking apart of the cake layers may require replacement of the layers, leading to additional time and expense to make the cake.

Accordingly, an apparatus facilitating the cake-making process for multi-layered cakes would be advantageous.

### SUMMARY OF THE INVENTION

One aspect of the present invention is an apparatus for stacking multi-layer cakes without breaking the layers. The apparatus includes a base member having a generally elongated shape suitable for grasping by a user. The apparatus further includes a plurality of elongated rods or the like connected to the base member and extending from the base member. The elongated rods are generally parallel to one another. An alignment member movably engages at least two of the elongated rods, and permits movement of the alignment member along the elongated rods. The alignment member includes a plurality of engagement surfaces contacting the elongated rods and holding the elongated rods in a generally parallel relationship to one another.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an isometric view of a cake stacking apparatus according to one aspect of the present invention;

FIG. 2 is an isometric view of the cake stacking apparatus of FIG. 1 wherein an alignment member is disposed directly adjacent the base member;

FIG. 3 is an exploded isometric view showing a cake being turned over onto a conventional cake rack;

FIG. 4 is an isometric view of the apparatus of FIG. 1 wherein the cake stacking apparatus is supporting a layer of a cake;

FIG. 5 is an isometric view showing the cake stacking apparatus of FIG. 1 immediately prior to positioning of the cake layer onto another cake layer;

FIG. 6 is an isometric view of the cake stacking apparatus showing the upper cake layer positioned on the lower cake layer;

FIG. 7 is an isometric view showing the cake stacking apparatus being removed from between the layers of the cake; and

FIG. 8 is an isometric view of the cake stacking apparatus of FIG. 1 showing an alignment member being reassembled with the base.

### DETAILED DESCRIPTION OF PREFERRED EMBODIMENT

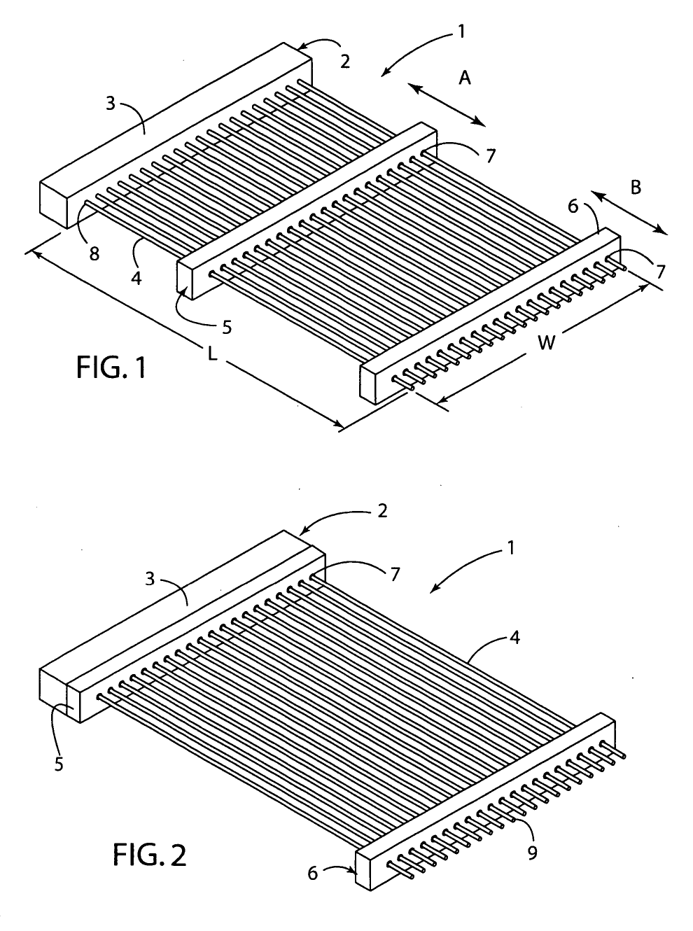

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a cake stacking apparatus 1 includes a base 2 including a base member 3, and a plurality of elongated rods 4 extending from the base member 3. First and second alignment members 5, 6, respectively include a plurality of openings 7 that slidably receive the elongated rods 4. The first and second alignment members 5 and 6 can be moved along the elongated rods 4 in the directions of the arrows “A” and “B”.

Although the base member 3, elongated rods 4, and first and second alignment members 5 and 6, respectively, could be made from a wide variety of materials, in the illustrated example the base member 3 and first and second alignment members 5 and 6, respectively, are made of wood, and the elongated rods 4 are made of steel. In the illustrated example, the elongated rods 4 have a diameter of about 3/32 (about 0.030 inches), and the elongated rods 4 are spaced apart about 0.75 inches. In the illustrated example, the elongated rods 4 have a cylindrical outer surface that is substantially smooth. The elongated rods 4 may be spaced apart a larger or smaller amount, but a spacing of about 0.75 inches to 1.00 inches is preferred. Also, it will be readily understood that the elongated rods 4 could be integrally formed with the base member 3 to form a one-piece base 2. Base ends 8 of elongated rods 4 are fixedly secured to the base member 3.

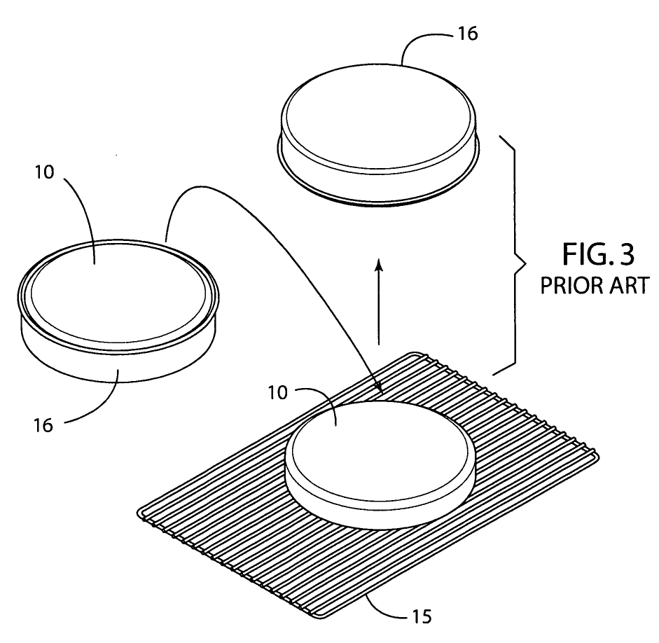

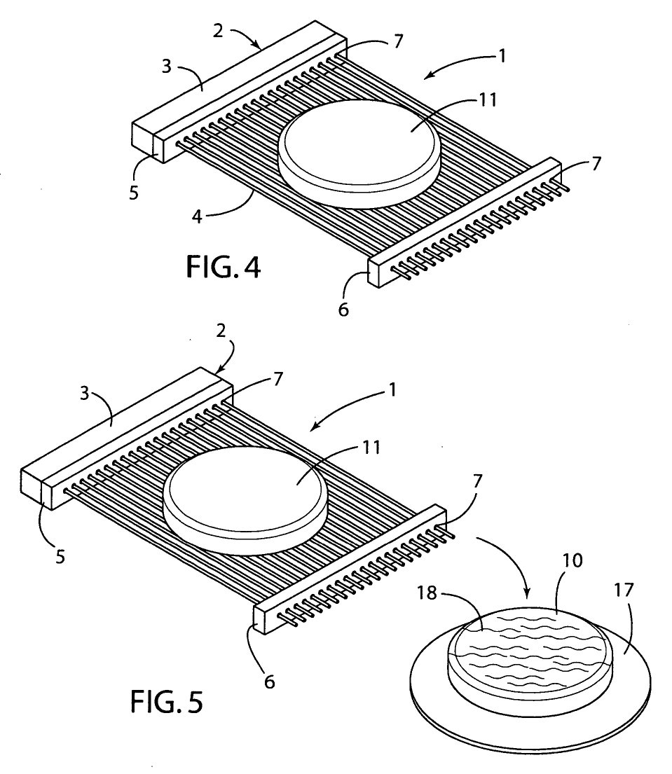

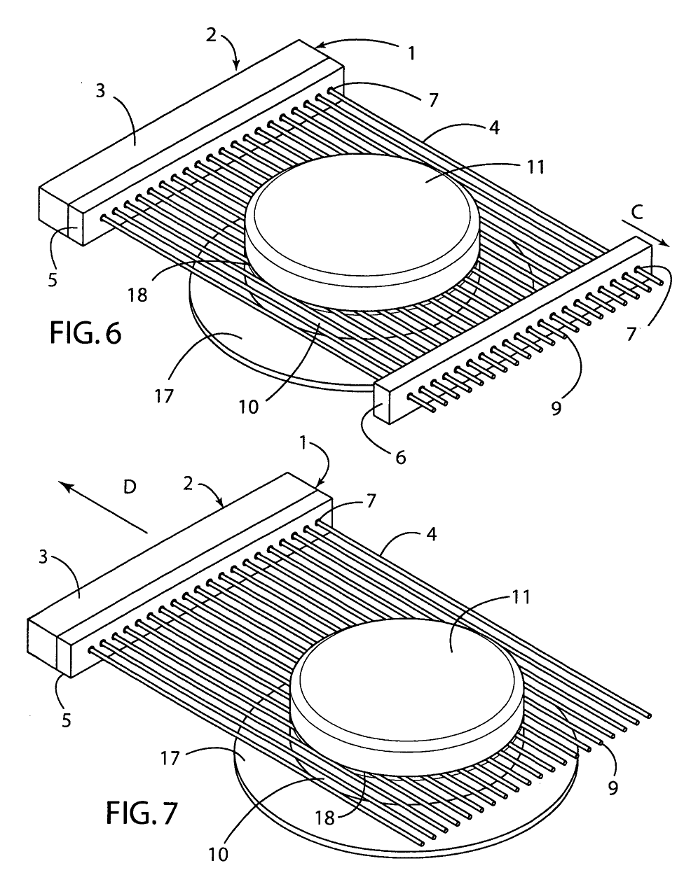

In use, the first alignment member 5 is positioned against or directly adjacent the base member 3 (FIG. 2), and the second alignment member 6 is positioned adjacent the distal ends 9 of the elongated rods 4. With reference to FIG. 3, a cake layer 10 is turned over onto a conventional cake rack 15, and the pan 16 is then removed. The cake layer 10 is then positioned on a conventional surface 17 (see also FIG. 5). A second cake layer 11 is then positioned on the elongated rods 4 of the stacking apparatus 1 utilizing a cake rack 15 as illustrated in FIG. 3. Frosting 18 or the like is utilized to cover the first cake layer 10, and the second cake layer 11 is then positioned directly above the first cake layer as illustrated in FIG. 6. In this position, the elongated rods 4 pass through the frosting 18 on cake layer 10, and help support the second cake layer 11 in position on the first cake layer 10.

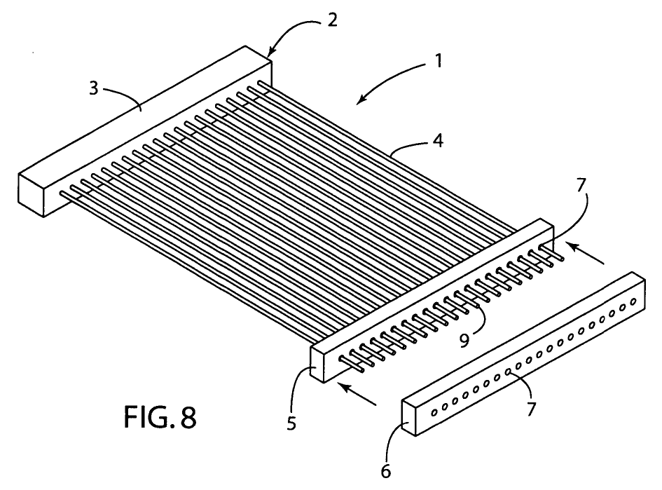

The second alignment member 6 is then pulled off the elongated rods 4 by moving the second alignment member 6 in the direction of the arrow “C” (FIG. 6). With further reference to FIG. 7, the base 2 (including elongated rods 4) and first alignment member 5 are then moved in the direction of the arrow “D” to slide the elongated rods from between the first cake layer 10 and the second cake layer 11. If necessary, the first cake layer 10 and/or second layer 11 are held in position by the user to thereby maintain the position of the second cake layer 11 relative to the first cake layer 10.

After the elongated rods 4 are pulled out from between the cake layers 10 and 11, any frosting or the like that is on the rods 4 is removed, and the cake stacking apparatus 1 may then be configured to repeat the process. To reconfigure the cake stacking apparatus 1, the first alignment member 5 is first slid away from the base member 3 to a position adjacent the distal ends 9 of elongated rods 4. The first alignment member 5 thereby ensures that the elongated rods 4 are properly positioned at the proper spacing to facilitate positioning of the second alignment member 6 onto the ends 9 of elongated rods 4. The first alignment member 5 may then be slid along the elongated rods 4 to the position illustrated in FIG. 2 so the cake stacking apparatus 1 may be utilized to position and stack additional cake layers.

In the illustrated example, the first alignment member 5 is utilized to properly position the distal ends 9 of the elongated rods 4. In general, elongated rods 4 tend to be somewhat flexible due to the relatively small diameter of the elongated rods 4 relative to the length of the rods 4, such that the first alignment member 5 greatly facilitates repositioning of the second alignment member 6 onto the distal ends 9 of elongated rods 4. However, the second alignment member 6 may be positioned onto the distal ends 9 of elongated rods 4 without use of first alignment member 5. According to other aspects of the present invention, the elongated rods 4 may be sufficiently rigid to prevent substantial misalignment of the elongated rods 4 relative to one another, such that the second alignment member 6 may be readily positioned on the distal ends 9 of the elongated rods 4 without use of the first alignment member 5. Also, the openings 7 in the second alignment member 6 may have a tapered opening or the like to facilitate insertion of the ends 9 of elongated rods 4. Elongated rods 4 may be made of stainless steel, ceramic, or other non-corrosive material.

The cake stacking apparatus 1 may have a variety of sizes as required for a particular application. In general, cakes having a diameter of 10, 12, 16 and 18 inches are commonly utilized, such that the dimensions of the cake stacking apparatus 1 may be appropriate to support cake layers having 10, 12, 16 and 18 inch diameters. In a preferred embodiment, the elongated rods 4 are configured to extend several inches beyond the outer edges of an 18 inch cake layer, such that the dimension “W” (FIG. 1) is about 22 inches. The length “L” of the elongated rods 4 is preferably at least about 22 inches in this embodiment. It will be readily understood that the dimensions “W” and “L” may be larger or smaller as required for a particular application.

The cake stacking apparatus 1 of the present invention provides a quick and easy way to position cake layers in a stacked arrangement without breaking or crumbling of the cake layers. The cake stacking apparatus 1 is cost-effective and durable, and alleviates long-standing problems associated with making multi-layered cakes, particularly in commercial settings and the like.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An apparatus for stacking one or more layers of a multi-layer cake, the apparatus comprising:
a base member having a generally elongated shape suitable for grasping by a user;
a plurality of elongated rods connected to the base member and extending from the base member, wherein the elongated rods are generally parallel to one another; and
an alignment member movably engaging at least two of the elongated rods and permitting movement of the alignment member along the elongated rods, the alignment member including a plurality of engagement surfaces contacting the elongated rods and maintaining the elongated rods in a generally parallel relationship to one another.

2. The apparatus of claim 1, wherein:
the rods define a first end that is rigidly connected to the base member.

3. The apparatus of claim 1, wherein:
each of the elongated rods defines an axis, and wherein the axes lie in a plane.

4. The apparatus of claim 1, wherein:
the elongated rods have cylindrical outer surfaces.

5. The apparatus of claim 4, wherein:
the outer surface of the elongated rods are substantially smooth.

6. The apparatus of claim 4, wherein:
the cylindrical outer surfaces of each of the elongated rods have the same diameters.

7. The apparatus of claim 1, wherein:
the alignment member includes a plurality of openings therethrough forming the engagement surfaces; and wherein:
the elongated rods extend through the openings in the alignment member.

8. The apparatus of claim 7, wherein:
the engagement surfaces; and:
the elongated rods define cylindrical outer surfaces.

9. The apparatus of claim 1, wherein:
the alignment member is disengagable from the elongated rods.

10. The apparatus of claim 9, wherein:
the elongated rods have base ends fixedly secured to the base member, and distal ends away from the base member, and wherein:
the alignment member can be disengaged from the elongated rods by moving the alignment member off the distal ends of the elongated rods.

11. The apparatus of claim 1, wherein:
the elongated rods are substantially rigid.

12. The apparatus of claim 1, wherein:
the base member is substantially rigid.

13. The apparatus of claim 1, wherein:
the elongated rods are made of a metal material, and the base member is made of a non-metallic material.

14. The apparatus of claim 1, wherein:
the alignment member comprises a first alignment member; and including:
a second alignment member movably engaging at least two of the elongated rods.

15. The apparatus of claim 14, wherein:
the first and second alignment members have a plurality of openings therethrough; and wherein:
the elongated rods extend through the openings.

16. The apparatus of claim 15, wherein:
the openings through the first and second alignment member form rows of equally spaced-apart openings.

17. The apparatus of claim 16, wherein:
the elongated rods have a diameter of about 0.030 inches, and the elongated rods are spaced apart about 0.750 inches.
